(19) United States
(12) Patent Application Publication
(10) Pub. No.: US 2004/0179907 A1
(43) Pub. Date: Sep. 16, 2004

(54) Reaming tool for flexible tubing

(76) Inventor: James MacDuff, Victoria (CA)

Correspondence Address: DORITY & MANNING, P.A., POST OFFICE BOX 1449, GREENVILLE, SC, 29602-1449, US

(21) Appl. No.: 10/387,965

(22) Filed: Mar. 13, 2003

(51) Int. Cl. B23B 51/00

(52) U.S. Cl. 408/1 R; 408/80; 408/211

(57) ABSTRACT

A reaming tool for a flexible tubing has cutting blades mounted in a spaced-apart relationship with a base of a shaft that is inserted into an end of the tubing. The blades cut a bevel on an outer periphery of the tubing so that an aluminum layer of a composite tubing is cut back from the end of the tubing to inhibit bi-metal corrosion when a tubing joint is formed using a tubing connector made of copper or brass.

### CROSS-REFERENCE TO RELATED APPLICATIONS

This is the first application filed for the present invention.

### MICROFICHE APPENDIX

Not Applicable.

### TECHNICAL FIELD

The present invention relates to the joining of flexible tubings and, in particular, two reaming tools used to prepare such tubings to receive a connector.

### BACKGROUND OF THE INVENTION

flexible tubings such as cross-linked polyethylene and plastic/metallic composite tubings such as thermoplastic/aluminum composites are widely used in wide variety of domestic and commercial fluid delivery or distribution applications.

Composite tubings have now become the standard conduit for hydronic heating systems. Those composite tubings generally include an inner layer of polyethylene, a middle layer of welded aluminum and an outer layer of polyethylene. It is common practice to use copper or brass connectors for joining such tubings to manifolds, zone valves, holding tanks, T-junctions, and other components in hydronic heating systems. In other to facilitate the insertion of a connector into an end of the tubing, it is common practice to use what is commonly referred to as a “reaming tool”, which stretches the tubing to accept the connector and prepares an outer end of the tubing to facilitate insertion of the connector.

FIG. 1 is a schematic, cross-sectional view of a composite tubing 10 that has been prepared to receive a connector in accordance with a prior art reaming tool described, for example, in applicant's U.S. Pat. No. 6,523,862 which issued on Feb. 25, 2003. As described above, the composite tubing 10 includes a thermoplastic inner layer 12, typically of polyethylene and an outer layer 14, normally of the same material. The inner and outer layers are bonded to an intermediate aluminum layer 16 is a thin-walled aluminum tubing having sonically welded seams to provide strength and eliminate air intrusion through the thermoplastic layers 12-14 into an interior 18 of the tubing. As is apparent, after having been prepared to receive a fitting using a prior art reaming tool (not shown) the open end 20 of the tubing 10 includes an inner bevel 22 that guides the connector into the interior 18 of the tubing as the connector is inserted into the tubing. As is well known in the art, as the bevel is cut, the reaming tool tends to force the exposed end of the intermediate aluminum layer 16 outwardly towards the periphery of the tubing, forming a thin aluminum layer 24 over the top part of the bevel 22.

A phenomenon referred to as “bi-metallic corrosion” occurs when the similar metals contact in a conducive environment. Consequently, when the thin aluminum layer 24 contacts a brass fitting (not shown) corrosion normally occurs. The rate of corrosion depends on environmental factors. The corrosion degrades both metals but normally has a more pronounced affect on the integrity of the intermediate aluminum layer 16. That corrosion may eventually adversely affect the strength of the tubing 10.

There therefore exits a need for a reaming tool that prepares composite tubing so that the probability of bi-metal corrosion resulting from contact between the aluminum layer of a composite tubing and a fitting use to join the tubing to another component in a fluid distribution system is reduced.

### SUMMARY OF THE INVENTION

It is therefore an object of the invention to provide a reaming tool for preparing flexible tubing to receive a metallic connector.

It is a further object of the invention to provide a reaming tool for preparing a composite tubing to receive a metallic connector in such a way that the probability of bi-metallic corrosion is reduced when the connector is secured in an end of the tubing.

The invention therefore provides a reaming tool for preparing a flexible tubing to receive an end of a connector. The reaming tool comprises a shaft adapted to be inserted into an end of the tubing, a handle for supporting the shaft, and at least one blade supported by the handle at a base of the shaft and spaced from a side of the shaft. The at least one blade is adapted to cut a bevel around an outer periphery of an end of the tubing into which the shaft is inserted when the shaft is rotated in at least a first direction.

In one embodiment, the shaft includes a spiral ridge adapted to frictionally engage an inner wall of the tubing and to draw the shaft into the tubing as the reaming tool is rotated in the first direction.

The shaft is preferably slightly larger than an inner diameter of the tubing so that the tubing is stretched as the shaft is inserted into the tubing in order to facilitate entry of the connector into the end of the tubing.

The invention further provides a method of preparing an end of a composite tubing to receive a connector. In accordance with the method, a bevel is cut on an outer periphery of the end of the composite tubing so that an outer thermoplastic layer and an intermediate aluminum layer are removed from area adjacent the end, while an inner thermoplastic layer is left substantially intact. In accordance with the method, the bevel is cut by inserting a shaft of a reaming tool into the end of the composite tubing, and rotating the reaming tool to move at least one cutting blade against the outer periphery of the end of the tubing to cut the bevel.

### BRIEF DESCRIPTION OF THE DRAWINGS

Further features and advantages of the present invention will become apparent from the following detailed description, taken in combination with the appended drawings, in which:

FIG. 1 is a schematic, cross-sectional view of a composite tubing prepared to receive a metallic connector using a prior-art reaming tool;

FIG. 2 is a side elevational view of a reaming tool in accordance with the invention;

FIG. 3 is a bottom plan view of the reaming tool shown in FIG. 2;

FIG. 4 is a side elevational view of another embodiment of a reaming tool in accordance with the invention, adapted to be used for preparing three different sizes of tubings for receiving a connector;

FIG. 5 is a cross sectional view of a composite tubing prepared to receive a connector using a reaming tool in accordance with the invention; and

FIG. 6 is a cross sectional view of the tubing shown in FIG. 5 with a connector inserted into the end of the tubing.

It will be noted that throughout the appended drawings, like features are identified by like reference numerals.

### DETAILED DESCRIPTION OF THE PREFERRED EMBODIMENT

The invention provides a reaming tool for preparing flexible tubing to receive a metallic connector. The reaming tool is particularly adapted to prepare a thermoplastic/metal composite tubing such as a polyethylene/aluminum tubing commonly used as fluid conduit in a variety of domestic and commercial applications. The invention further provides a method of preparing a composite tubing to receive a metallic connector by cutting a bevel on an outer periphery of the tubing.

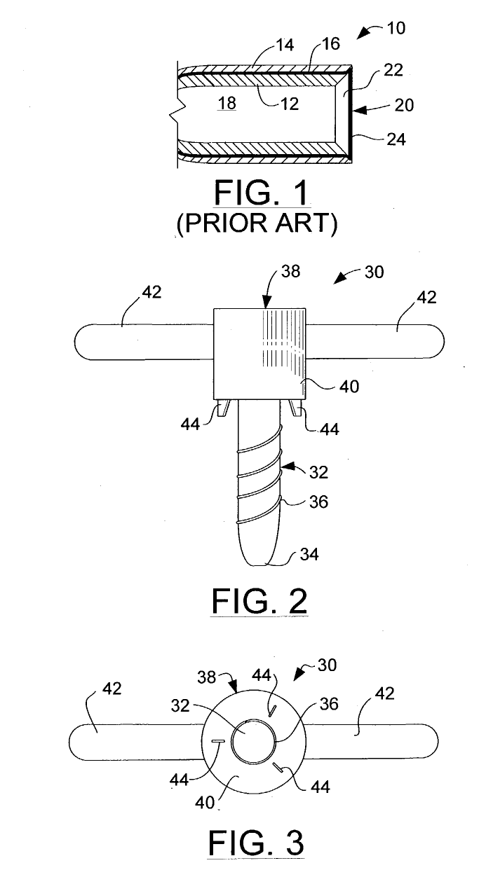

FIG. 2 is a schematic diagram of a side elevational view of a reaming tool 30 in accordance with the invention. The reaming tool 30 includes a shaft 32 that is inserted into an open end 20 of the tubing 10 that is to be prepared to receive a fitting. The shaft 32 is normally slightly larger than a diameter of an interior 18 (FIG. 1) of the tubing 10 so that insertion of the shaft into the open end of the tubing slightly stretches the tubing to facilitate insertion of the connector. In one embodiment, the shaft 32 has a tapered end 34 to facilitate entry of the shaft into a tubing 10. In another embodiment, the shaft 32 further includes a spiral ridge 36 that grips an inner wall of the tubing 10 and draws the reaming tool 30 into the tubing as the reaming tool is rotated in a first, normally clockwise, direction. The shaft 32 is connected to and supported by a handle 38 which includes a central hub 40 and levers 42 that provide leverage to facilitate insertion of the shaft 32 into the tubing 10. The central hub 40 of the handle 38 supports at least one blade 44. The blades 44 are spaced from a side of the shaft 32. Each blade 44 is adapted to cut a bevel around an outer periphery of the end of the tubing 10 into which the shaft 32 is inserted when the shaft is rotated in at least the first direction.

FIG. 3 is a bottom plan view of the reaming tool 30 shown in FIG. 2. As is apparent, in this embodiment of the invention, the reaming tool 30 is provided with three blades 44 affixed to the hub 40 of the handle 38 in a triangular pattern.

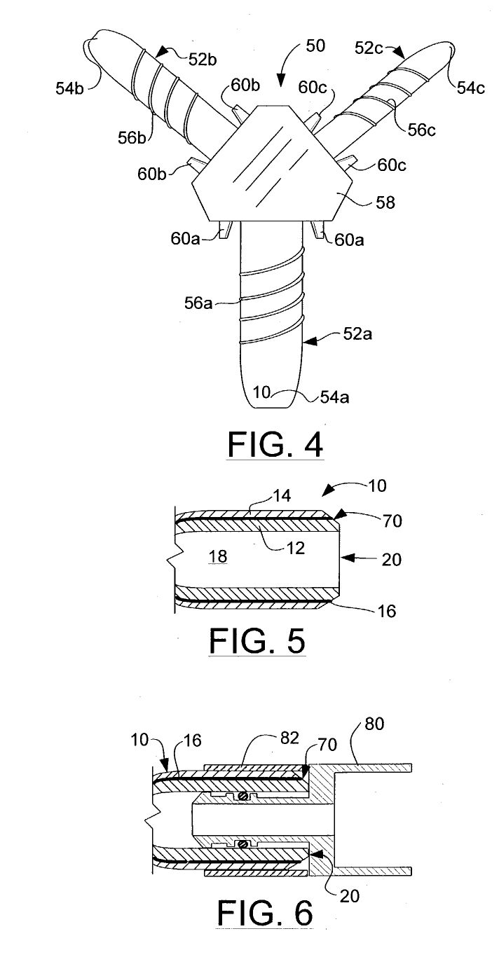

FIG. 4 is a schematic, side-elevational view of a second embodiment of a reaming tool in accordance with the invention. The reaming tool 50 shown in FIG. 4 includes three shafts 52a, 52b, and 52c, respectively. Each shaft has different diameter for preparing a different size of tubing 10, e.g. one inch, three-quarter inch, and one half inch, respectively. Each of the shafts 52a-c include a tapered end 54a, 54b and 54c. Each shaft 52a-c likewise includes a spiral ridge 56a, 56b and 56c, respectively. The three shafts 52a-c are connected to and ridgedly supported by a hexagonal hub 58. The hub 58 supports at least one blade 60a, 60b and 60c in a spaced relationship with a side of the respective shafts 52a, 52b and 52c. In one embodiment, three blades are supported at a base of each shaft similarly to the embodiment described above with reference to FIG. 3. The blades 60A-60C are adapted to cut a bevel on an external periphery of the tubing 10 when an appropriate one of the shafts 54A-C is inserted into the tubing as described above with reference to FIG. 2.

FIG. 5 is a schematic cross-sectional view of a composite tubing 10 prepared for the insertion of a metallic fitting using a reaming tool in accordance with the invention. The end 20 of the tubing 10 is normally cut square as a first step in preparing the tubing 10 to receive a connector. A reaming tool 30, 50 with an appropriately sized shaft 32, 52 is then selected and the reaming tool 30, 50 is rotated in the first direction until the blades 44, 60 are drawn into contact with the tubing and cut a bevel 70 around on outer periphery of the tubing 10. Cutting the bevel 70 on the outer periphery of the tubing prevents the intermediate aluminum layer 16 from contacting the connector, as will be explained in more detail below with reference to FIG. 6. Furthermore, since the tubing is being stretched by the insertion of the shaft 32, 52, the tubing material is compressed between the blades 44, 60 and the shaft 32, 52. Consequently, the blades 44, 60 tend to cut the intermediate aluminum layer 16 much more cleanly as shown in FIG. 5, and a thin layer of the aluminum is not splayed against the cut surface.

FIG. 6 is a schematic cross-sectional view of a brass fitting 80 inserted into an end of the tubing 10 prepared using a reaming tool 30, 50 in accordance with the invention. The brass fitting includes a fitting body 80, for example, a tubing connector as described in applicant's U.S. Pat. No. 6,095,571 which issued on Aug. 1, 2000, the specification of which is incorporated herein by reference, or U.S. Pat. No. 6,523,862, referenced above and likewise incorporated herein by reference.

The brass fitting 80 is used in conjunction with a crimp ring 82, which may be an integral part of the fitting 80 as described in applicant's U.S. Pat. No. 6,523,862. As is apparent, the bevel 70 formed on the outer periphery of the tubing 10 keeps the intermediate aluminum layer 16 of the composite tubing spaced well away from the fitting 80 and the crimp ring 82, while the tubing is adequately stretched by insertion of the shaft 32, 52 to permit the fitting 80 to be easily inserted into the open end 20 of the tubing 10. Furthermore, the thicker thermoplastic inner layer 12 of the tubing 10 prevents the intermediate aluminum layer 16 from being forced against the connector body 80. Consequently, bi-metal corrosion is avoided and the service life of the fitting 80 and the composite tubing 10 is improved.

Although the reaming tool 30, 50 in accordance with the invention has been described with particular reference to thermoplastic/aluminum composite tubing, it would be readily understood by those skilled in the art that the reaming tool and methods of preparing flexible tubing for receiving a metallic fitting are equally adapted to be used for the preparation of any flexible tubing, including cross-linked polyethylene tubings used in water distribution systems.

In should be further understood that although only two configurations of the reaming tool have been described, many other tool configuration are possible. The only important feature of the reaming tool is that a taper is cut on an outer periphery of the tubing, and optionally the tubing is stretched.

The embodiment(s) of the invention described above are therefore intended to be exemplary only. The scope of the invention is therefore intended to be limited solely by the scope of the appended claims.

I/we claim:

1. A reaming tool for preparing a flexible tubing to receive an end of a connector, comprising:
a shaft adapted to be inserted into an end of the tubing;
a handle for supporting the shaft; and
at least one blade supported by the handle at a base of the shaft and spaced from a side of the shaft, the at least one blade being adapted to cut a bevel around an outer periphery of the end of the tubing into which the shaft is inserted when the shaft is rotated in at least a first direction.

2. The reaming tool as claimed in claim 1 wherein the shaft comprises a spiral ridge adapted to frictionally engage an inner wall of the tubing and to draw the shaft into the tubing as the reaming tool is rotated in the first direction.

3. The reaming tool as claimed in claim 1 wherein the handle comprises at least one laterally extending lever for providing leverage to facilitate rotating the reaming tool in at least the first direction.

4. The reaming tool as claimed in claim 1 wherein the shaft is slightly larger than an inner diameter of the tubing, so that the inner diameter of the tubing is slightly enlarged as the shaft is inserted into the end of the tubing.

5. The reaming tool as claimed in claim 1 wherein the end of the shaft is tapered to facilitate insertion of the shaft into the end of the tubing.

6. A reaming tool for preparing an end of a flexible tubing to receive an end of a connector, comprising:
a plurality of shafts respectively adapted to be inserted into an end of a tubing of a respective predetermined diameter;
a hub to which the plurality of shafts are respectively mounted;
at least one blade supported by the hub at a base of each of the respective shafts and spaced from a side of each shaft, respective ones of the at least one blade being adapted to cut a bevel around an outer periphery of the end of the tubing into which the shaft is inserted when the shaft is rotated in at least a first direction.

7. The reaming tool as claimed in claim 6 wherein each shaft further comprises a spiral ridge adapted to engage an inner wall of the end of the tubing to draw the shaft into the tubing when the shaft is rotated in the first direction.

8. The reaming tool as claimed in claim 7 wherein each shaft further comprises a tapered distal end to facilitate entry of the shaft into the end of the tubing.

9. The reaming tool as claimed in claim 6 wherein the reaming tool comprises at least three shafts of different diameter.

10. A method of preparing an end of a composite tubing to receive a connector, comprising steps of:
cutting a bevel on an outer periphery of the end of the composite tubing so that an outer thermoplastic layer and an intermediate aluminum layer are removed from an area adjacent the end, but an inner thermoplastic layer is left substantially intact.

11. The method as claimed in claim 10 further comprising a step of cutting the end of the composite tubing to provide a substantially square end prior to cutting the bevel.

12. The method as claimed in claim 10 wherein the step of cutting the bevel comprises steps of:
inserting a shaft of a reaming tool into the end of the composite tubing; and
rotating the reaming tool to move at least one cutting blade against the outer periphery of the end of the tubing to cut the bevel.
